(19) United States
(12) Patent Application Publication
(10) Pub. No.: US 2015/0115870 A1
(43) Pub. Date: Apr. 30, 2015

(54) Flexible Wrist-Worn Recharging Device

(71) Applicant: Luke Alan Vance, Denver, CO (US)

(72) Inventor: Luke Alan Vance, Denver, CO (US)

(21) Appl. No.: 14/523,715

(22) Filed: Oct. 24, 2014

Related U.S. Application Data
(60) Provisional application No. 61/895,233, filed on Oct. 24, 2013.

(51) Int. Cl. H02J 7/00; G04G 19/00; A44C 5/00

(52) U.S. Cl. CPC H02J 7/0042; A44C 5/0061; G04G 19/00
USPC 320/101

(57) ABSTRACT

An electrical storage device incorporating embodiments of the invention is capable of converting and/or storing energy provided by light-radiation and ancillary power sources for use intended to provide electrical charge to battery operated and Mobile Electronic Devices. The preferred embodiment of the invention exhibits a form of a Wrist-Worn Device comprising of a Battery-Bank, Photovoltaic Array and Controller. Typically in the form of a Flexible Wrist-Worn Recharging Device, the preferred embodiment of the invention may be an independent device connected to battery-operated devices such as a Mobile Electronic Device as needed, or otherwise integrated with exiting Mobile Electronic Devices to provide augmented battery life.

CROSS-REFERENCE TO RELATED APPLICATIONS

This application claims the benefit of U.S. Provisional Application 61/895,233 filed Oct. 24, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

A mobile technology-centric society exhibits an increasingly pervasive utilization of mobile electronic devices. Mobile technology has enabled a more efficient workplace, communication modes and execution of common everyday tasks. Such tasks include even mundane tasks such as identifying the most efficient route home or finding the nearest market. A requirement necessary to enable useful access to and ongoing usage of mobile devices is a portable and reliable energy supply. Due to increasing reliance upon Mobile Electronic Devices, mechanisms for portable electronic energy storage, back-up batteries and alternative mechanisms to provide supplementary charge to Mobile Electronic Devices remains an ongoing need.

As the use of portable and mobile electronic devices increases so does reliance on such technologies on both an individual and a societal level. It will be appreciated that “Mobile Electronic Device” as used herein, refers to any untethered, often battery powered, untethered mobile or portable electronic device or apparatus including but not limited to cellular phones, smart-phones, portable computers and portable guidance systems.

Until recently, mobile technology primarily provided a complement to commonly used and relied-upon infrastructure such as a desktop computer or land-line phones. Now, however, mobile technology provides the primary basis of communication for many. Typical users of mobile technology include those that conduct business primarily over mobile technology devices.

As a result, a depleted battery charge creates an undesirable situation that may cause inconvenience. The inconvenience may be minor, such as an inconvenience that relates to tardiness to a meeting or loss of income from missed business opportunities. However, the inconvenience may be more major, such as an inconvenience interfering with communication in emergency situations or other negative scenarios.

Some previously known items address the problem of on-the-go charging for Mobile Electronic Devices related to the use of a pre-charged battery pack or battery-bank. It will be appreciated by one skilled in the art that a charged battery-pack or “Battery-Bank” provides the storage of untethered electrical power for use in supplying power to operate or charge other electrically-based components such as a Mobile Electronic Device. These items related to the storage of untethered electrical power can be effective in providing a charge when needed. However, several problems generally associate with such items. For example, they cannot be charged without an additional power source. This generally renders them useless after the electrical power stored in such devices has been depleted before the user is able to use another power source such as a wall outlet, automobile accessory port or secondary computing device to replenish the charge.

Some items in the prior art relate to a wearable power recharging solution for Mobile Electronic Devices. Often, such items utilize the inherent surface area of a watch face or watch housing to generate charge through the use of a solar-array. Such solutions provide portable and self-replenishing battery storage to supplement the existing battery charge of personal electronics. The problem with this strategy to charging a Battery-Bank with the surface area of a watch face or watch housing is that the area provided is not sufficient to supply the needs of a Mobile Electronic Device.

Typically, a solar-array requires more surface area than is available in many prior art solutions to provide adequate power to recharge a Battery-Bank capable of recharging of a mobile device battery. Solar energy conversion is directly proportional to size of a solar array or Photovoltaic Array, comprising of at least one photovoltaic cell. Currently, the highest-efficiency commercially available photovoltaic cells have a solar energy to electricity conversion efficiency of approximately 22%.

The power generated by a photovoltaic array of given area is determined by the following equation: P=(Avg. Solar Irradiance×Atmospheric Deficiency)×(Area×Efficiency). It will be appreciated that Average Solar Irradiance relates to average amount of energy associated with the sun striking a given area unimpeded by atmospheric deficiencies or the like with a commonly accepted value of 1000 W/m̂2. It will be further appreciated that Atmospheric Deficiency relates to the energy loss associated with travelling through the atmosphere with a Northern Hemispheric values typically ranging from 75-90% and commonly used average of 84%.

Since the most efficient photovoltaic cells commercially available have an efficiency rating of 22% there is a physical size minimum for producing a 0.5 Watt system solved by calculating for the Area given a power requirement of 500 mW or 0.5 W. That limit is 2,706 mm̂2 (Area=0.5 W/[1000(W/m̂2)×0.84×0.22]). A watch housing of minimum 2706 mm̂2 dictates a watch housing of a major dimension of at least 58.70 mm (2.31 in). Thus, a watch face charging device as known in the prior art lacks the effective area for recharging such a Battery-Bank unless the watch face is impractically large.

Other items in the prior art attempt to solve the problem of the depleted battery of a Mobile Electronic Device by incorporating a solar array around the outer surface of a rigid bracelet or bangle. Although such prior art items attempts to solve problems associated with lacking surface area by maximizing or extending available surface area able to collect solar energy to provide recharging power to an integrated Battery-Bank, such items generally fail to account for the point source characteristics of the provided solar energy. As a result, such items in the prior art are not able to use the full solar collection potential of the maximized array surface area.

In some situations a user may want to provide charge to their phone while recharging a Battery-Bank for future use. Typical items in the prior art do not allow for such wearable solar array enabled Battery-Banks to be recharged from an alternate power source such as a home power outlet or vehicle accessory power port while simultaneously providing pass-thru power to the Mobile Electronic Device.

In other scenarios, a plurality of users of a solar array-enabled Battery-Bank recharging devices may want to combine the power in each of their Battery-Banks to recharge a singular Mobile Electronic Device. Items in the prior art do not enable the serial connection of such items, commonly referred to as “Daisy-Chaining,” to effectively provide a singular Battery-Bank of higher voltage and output capacity for a faster and/or more effective recharge to the Mobile Electronic Device.

Furthermore, the items available in the prior art do not allow for the accessory use of a supplemental power source and/or supplemental power generation with existing wearable technology such as a battery enabled wrist-band to be integrated with a discrete existing product such as a smart-watch.

### SUMMARY

An electrical storage device incorporating embodiments of the invention is capable of converting and/or storing energy provided by light-radiation, for use intended to provide battery charge to battery operated and Mobile Electronic Devices. Alternatively, the device can be connected to other traditional power sources such as 110V outlets, vehicle power accessory outlets and the like to store energy for later use in providing battery charge to a Mobile Electronic Device.

The preferred embodiment of the invention comprises a wrist-band incorporating light-radiation collection devices around its circumference. The preferred embodiment of the invention provides charge to an integrated Battery-Bank for use in providing recharge to an ancillary device or plurality of ancillary devices, especially a singular Mobile Electronic Device or plurality of Mobile Electronic Devices.

The preferred embodiment of said invention exhibits flexibility characteristics enabling the user to lay a wrist-worn electrical storage device to maximize solar exposure when fully extended. The flexible nature of the apparatus enables the full extension of the device, thus maximizing the potential surface area exposure to the sun and the electricity generation potential of the unit. Furthermore, the preferred embodiment of the invention enables the user to link said potential device in series with other power sources, including other wrist-worn electrical storage devices such as those described herein, to provide increased power supply to a depleted Mobile Electronic Device and/or to coordinate recharge of the Battery-Bank with the battery of said Mobile Electronic Device.

Further, the preferred embodiment of the invention additionally or alternatively enables the use of a wrist-worn electrical storage device with an existing Mobile Electronic Device, such as a smart-watch, to prolong the effective battery life of such a device.

### BRIEF DESCRIPTION OF DRAWINGS

FIG. 1A is a perspective view of the preferred embodiment

FIG. 1B is a perspective view of an embodiment

FIG. 2 is a top view of the preferred embodiment in a flat orientation

FIG. 3 is a top view of the preferred embodiment in a configuration as worn by a user

FIG. 4 is a perspective view of the two distal ends and connection mechanism

FIG. 5 is a perspective view of the Second Distal End

FIG. 6A is a top view of the First Distal End

FIG. 6B is a front view of the First Distal End

FIG. 7A is a top view of an embodiment enabling Daisy-Chaining prior to connection

FIG. 7B is a top view of an embodiment enabling Daisy-Chaining as connected in series

FIG. 8 is a perspective view of an embodiment enabling the integration with a Smart-Watch 20

FIG. 9 is a perspective view of an embodiment integrated with a smart watch charging on an Inductive Charging Surface

### REFERENCE NUMBERS IN DRAWINGS

1. Wrist-Worn Device
2. Watch Component
3. Main Housing
4. Photovoltaic Cell Comprising Photovoltaic Array
5. First Male USB Connector on First Distal End
6. Second Recess on Second Distal End for Mating with First Male USB Connector
7. Second Male USB Connector on Second Distal End
8. First Recess on First Distal End for Mating with Second Male USB Connector
9. Segment Comprising Second Distal End
10. Segment Comprising First Distal End
11. Pinned Joint Between Non-Flexible Segments
12. Male Mating Feature Providing Additional Attachment Stability Between Distal Ends
13. Female Mating Feature Providing Additional Attachment Stability Between Distal Ends
14. Non-Flexible Segment Comprising Flexible Assembly of Wrist-Worn Device 1
15. Longitudinal Axis of Wrist-Worn Device
16. Attachment Recess of Non-Flexible Segment
17. Preceding Wrist-Worn Device in a Daisy Chain Configuration
18. Separate disparate Wrist-Worn Device in a Daisy Chain Configuration
19. Embodiment of Invention Integrating with Smart-Watch
20. Inductive Charging Surface

### DETAILED DESCRIPTION

Mobile Electronic Devices, including smart-phones, require a minimum of 500 mA and stable 5V before accepting charge current. Therefore (0.5 A×5V=2.5 W) a 2.5 W power source is required to charge smart-phones. Many 3.7V-4.2V batteries can provide a stable 5V output when wired to a DC voltage regulator. However, the battery must be capable of providing a minimum output rate of 500 mA. The preferred embodiment of the invention incorporates battery size specifications of a supplementing Battery-Bank in accordance with such needs.

Battery selection may be driven not only by voltage and capacity, but also by charge/recharge rate specifications. If the battery has a capacity of less than 500 mAh, then it must have a discharge rating or C-rate of higher than 1 if the target battery, or the battery to be recharged, requires a minimum of 500 mA for a recharge operation.

It will be appreciated by one skilled in the art that battery recharge rate capabilities are quantified by what is commonly referred to as the C-Rate. The C-Rate is defined as the multiple of the current divided by the current said battery can sustain for one hour. For example, a 1 C rate means that a 1.0 Ah battery would be discharged in one hour at a discharge rate of 1.0 A, while A 2 C rate means that the same 1.0 Ah battery could discharge at a current of 2.0 A over the course of a half-hour. Accordingly, the recharging of such batteries follows the same logic in that a 1.0 Ah 1 C battery would take one hour to charge at a charge rate of 1.0 A and a 1.0 Ah 2 C battery could charge at a rate of 2.0 A in half the time, or 30 minutes.

Thusly, a 250 mAh battery with a maximum discharge rating of 2 C can provide an output current of 500 mAh. However, higher discharge results in lower efficiency in energy transfer. In order to avoid lower efficiencies with higher discharge rates and to provide enough output for a smart-phone battery, typically a 500 mAh battery, at least a 500 mAh Battery-Bank is preferred. As such, the preferred embodiment of the invention incorporates lithium-ion battery in the Battery-Bank that is larger than 500 mAh.

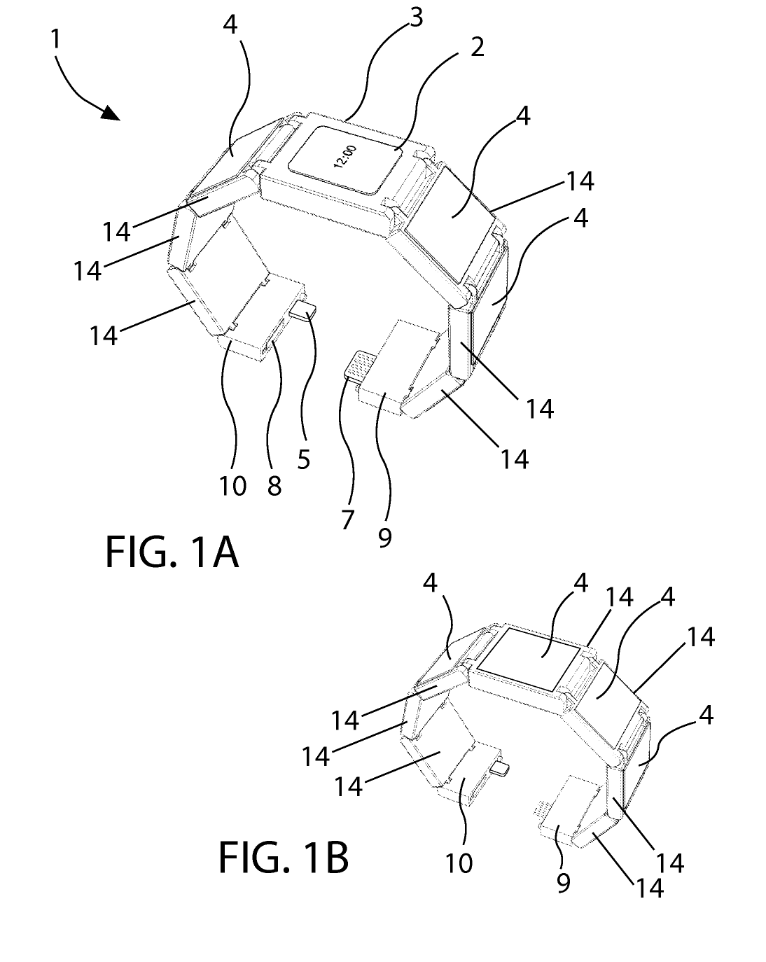

The present invention has recognized that in order to charge the battery from any source, a voltage higher than the lithium battery's voltage must be provided and a charge rate of at least 18% of the capacity must be used. Therefore, to effectively charge a battery of 3.7V voltage and 500 mAh capacity providing 1850 mWh power (3.7 V×500 mAh), a need solved by the embodiment of the invention disclosed herein, a power source, in this case a Battery-Bank providing power capacity of 333 mWh (1850 mWh×0.18), or one of similar power output must be provided. As such, in the preferred embodiment as demonstrated by FIG. 1A, said Battery-Bank, incorporated within the Main Housing 3, utilizes a 3.7V 500 mAh lithium-ion battery.

The present invention has recognized that because of basic inefficiencies in energy transfer and solar charge controlling circuits, a 5V (preferably 5.5V) output must be produced to eventually provide the 4.2V needed to charge the lithium battery of the Battery-Bank associated with the preferred embodiment. Considering that a 90 mA current must also be provided, an embodiment of the invention provides at least 450 mW (5V×0.09 A=0.45 W), while the solar array in the preferred embodiment provides minimum output of 5.5V at 80 mA.

The problem of a solar array not being able to generate enough electricity to charge an integrated Battery-Bank due to a lack of effective surface area is solved by the preferred embodiment of the invention comprising a Wrist-Worn Device 1 further comprising a Battery-Bank and photovoltaic array and utilizing the outer surface of the device, which is designed to be worn around a user's wrist. Said device may comprise a fashion accessory, functional watch, or other wrist-worn object. It will be appreciated by those skilled in the art that the Photovoltaic Array associated with embodiments of the invention comprises at least one and preferably a plurality of photovoltaic or “PV” cells 4 that convert light-radiation to electricity. The “Outer Surface” of the device as presented herein, refers to the surface of a Wrist-Worn Device 1 generally facing away from and generally not in contact with the user's body.

It will be further appreciated that most watch bands are 20-30 mm (0.787-1.18″ in width) and span 16-20 cm (6.30-7.87 in) in length providing for usable area of at least 3200 mm̂2 (5.89 in̂2). Thus, the Photovoltaic Array as incorporated into the watch band in the preferred embodiment provides an area in excess of the needed area to produce electrical charge capable of recharging an integrated Battery-Bank, the Battery-Bank intended to recharge a Mobile Electronic Device such as a smart-phone.

The preferred embodiment of the invention solves the problem of limited potential collection of solar energy associated with typical devices worn on or near wrists, as illustrated by the Wrist-Worn Device 1. The preferred embodiment employs the use of a Wrist-Worn Device 1 comprising of a flexible wrist-strap of dimension of at least 20 mm (0.787 in) in width and at least 16 cm (6.30 in) in length providing 3200 mm̂2 (4.96 in̂2) of usable area, designed for the integration of a Photovoltaic Array in excess of the necessary area of 2720 mm̂2 (4.22 in̂2). The preferred embodiment accommodates photovoltaic cells 4 comprising a Photovoltaic Array with an energy conversion efficiency of 22%. Said Photovoltaic Array comprises at least 4, and preferably 6 photovoltaic cells distributed around said wrist-strap with a minimum output of 5.5V at 80 mA (or approximately 450 mW) and more preferably still 6V×100 mA (or 600 mW) and single Battery-Bank comprised of a battery preferably of voltage rating of 3.7V-4.2V.

As used herein, the term “Flexible” implies an ability to easily modify in shape without breaking Such flexibility may be inherent property of a material utilized in an embodiment of the invention. Alternatively, flexibility associated with embodiments of the invention may derive from the assembly of a plurality of non-flexible segments 14 in such a manner that allows the assembly as a whole to exhibit flexibility. In one embodiment, such an assembly may comprise plurality of rigid parts or segments connected by a series of pinned 11 or hinged connections permitting at least one degree of rotational freedom from an adjacent segment.

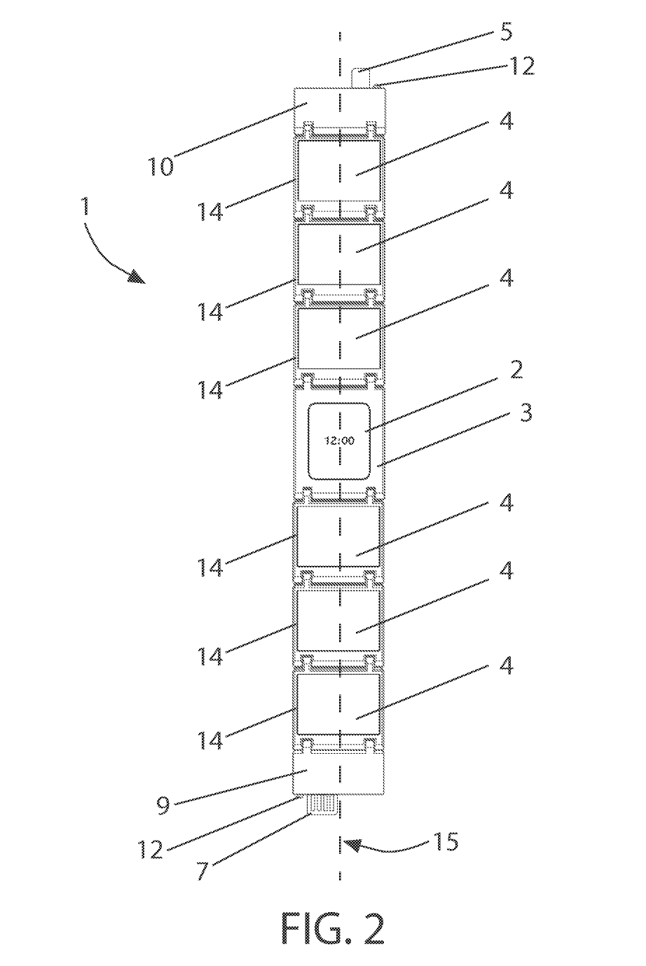

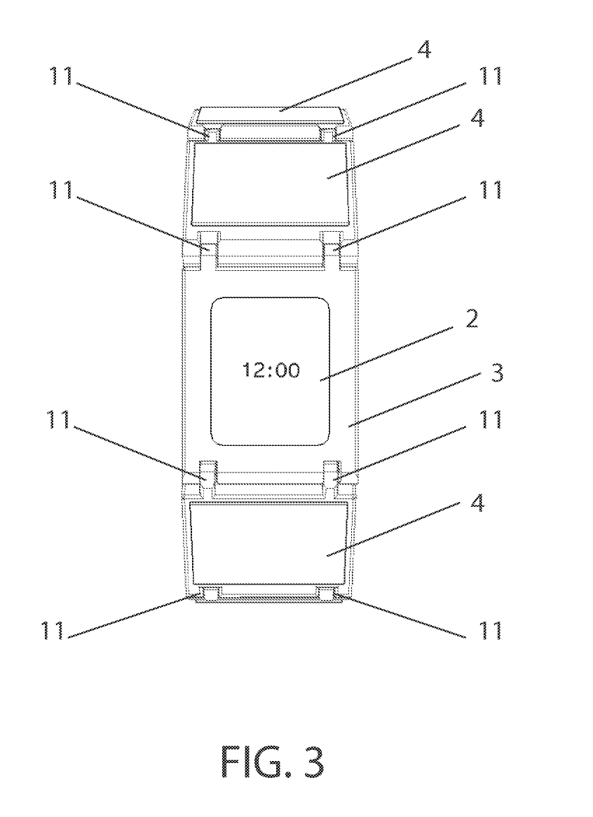

As demonstrated in FIG. 2, the preferred embodiment enables the user to arrange the Wrist-Worn Device 1 in a substantially flat orientation with the outer surface facing an energy source in order to maximize the power generation of the photovoltaic cells 4 by maximizing the exposure to available light radiation.

Embodiments of photovoltaic arrays include but are not limited to Photovoltaic array configurations of 6-1V photovoltaic cells each with a current output of 100 mA for a total potential output of 6V at 100 mA, Photovoltaic array configurations of 6-2V photovoltaic cells each with a current output of 50 mA, allowing for enough voltage generation to charge the battery at half-capacity, such as when said Wrist-Worn Device 1 is worn, and doubling current output to 100 mA when laid flat facing available light radiation and thereby charging the Battery-Bank at a doubled rate.

In an embodiment of the invention, the battery comprises of a plurality of segmented batteries within interconnected non-flexible segments 14 to enable the distributed integration of the Battery-Bank into the wrist strap.

It will be appreciated by one skilled in the art that “Controller,” in the context of a Wrist-Worn Device 1 which charges a Battery-Bank using photovoltaic cells, comprising at least one controlling circuit. Said single controlling circuit or plurality of controlling circuits include, without limitation, battery charge circuits and voltage regulation circuits. In the preferred embodiment, the Controller comprises of a Battery Charge Circuit to stabilize the incoming current for charging the Battery-Bank and a Voltage Regulation Circuit to regulate the voltage output from the battery to a connected Mobile Electronic Device. In an embodiment of the invention, the Battery-Bank, comprised of at least one battery, has an overall voltage rating of at least 3.7V and capacity of at least 500 mAh.

In an embodiment of the invention, a Wrist-Worn Device 1 comprising a Photovoltaic Array, a controller integrated within the Main Housing 3, a Battery-Bank and a wrist strap further comprising at least one USB connector. It will be further appreciated by one skilled in the art that a standard USB connector refers to any widely used connection device utilizing the Universal Serial Bus transfer protocol. This includes but is not limited to USB A-Type, USB B-Type, Micro-USB A, Micro-USB B, Micro-USB AB, Micro-USB C, USB Mini-B, USB A-Type 3.0, USB B-type 3.0, USB 3.0 Micro B, and Lightning connector USB connectors. In an embodiment of the invention, the USB male connector is integral in the wrist strap where the two distal ends of the wrist strap join to form a loop around the user's wrist. Said USB connector device is used to connect said Wrist-Worn Device 1 to a Mobile Electronic Device to provide said Mobile Electronic Device additional battery charge from stored energy within the Battery-Bank.

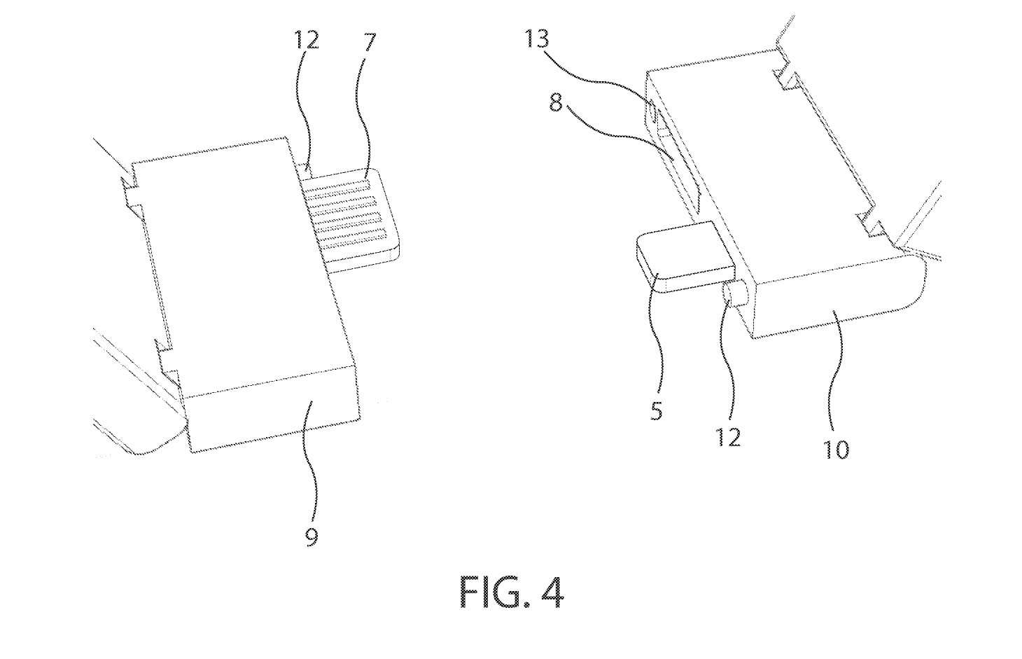

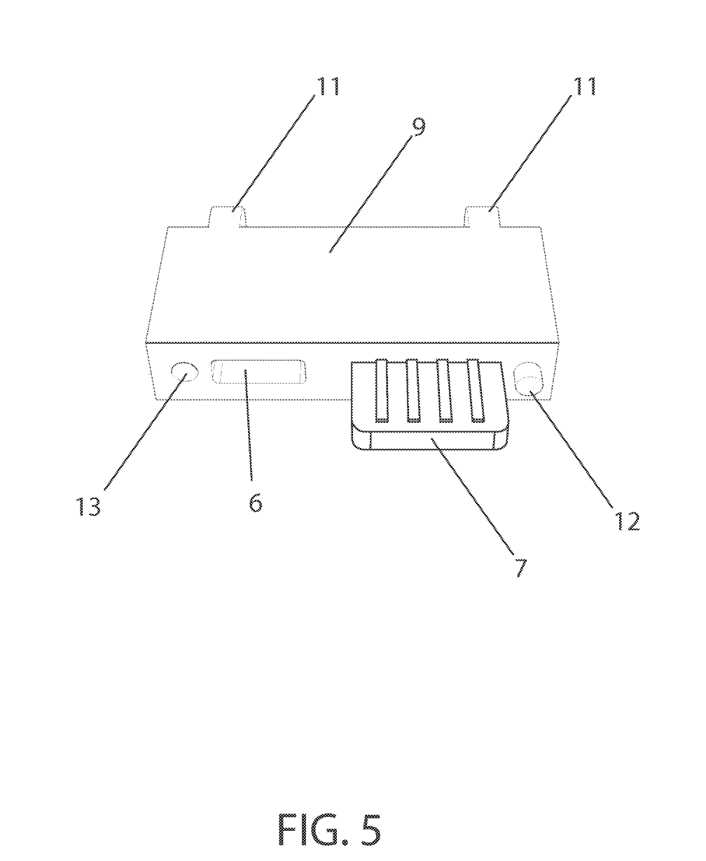

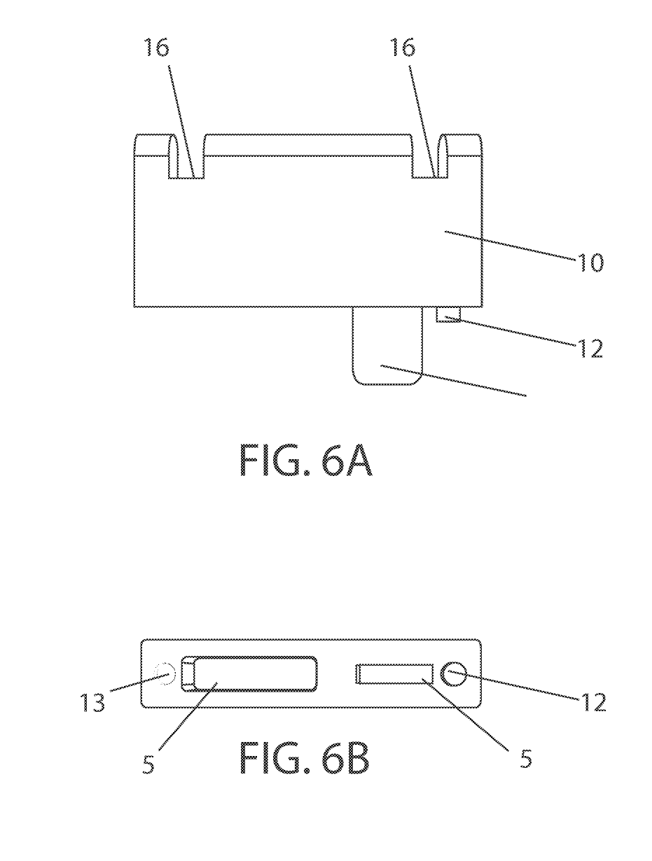

In the preferred embodiment, a Wrist-Worn Device 1 comprised of a Photovoltaic Array, Controller, Battery-Bank and wrist strap further comprises of two male USB connectors 5 and 7. Said USB connectors may be of differing types such as USB A-Type and lightning USB connection. Furthermore as illustrated by FIG. 4, recesses 6 and 8 in the opposite distal ends accept and provide constraint to said USB connectors to attach the distal ends of the Wrist-Worn Device 1 to each other and thereby constrain the Wrist-Worn Device 1 around the user's wrist. Futhermore, in such embodiment, the use of male and female features provide additional attachment stability between distal ends.

The presence of two male USB connectors in the preferred embodiment of the invention forms a novel departure from prior art items, solving problems faced by prior art items associated with their inability to allow for coordinated or pass-thru charging when the user removes said Wrist-Worn Device 1 from their wrist and connects one end to a Mobile Electronic Device such as a smart-phone and the other end to an ancillary power source including but not limited to a Battery-Bank, 110V outlet using a standard power converter or a vehicle accessory power port.

It will be appreciated that “Pass-Thru” power mode occurs when the Controller of a Wrist-Worn Device 1 sends power directly to an attached Mobile Electronic Device without charging the Battery-Bank. Power provided in Pass-Thru mode may originate from an ancillary power source or light radiation converted to electrical power utilizing a solar array.

Within the preferred embodiment, the Controller may assess the power input provided by the ancillary power source, the power requirements of the integrated Battery-Bank and those of the Mobile Electronic Device. Based upon predetermined settings set by the user or by the manufacturer applied to the assessed power supply and requirements, the Controller may: 1. Provide direct Pass-Thru power, thereby prioritizing the charging of said Mobile Electronic Device 2; Perform a coordinated charging action by splitting the available power among both the Mobile Electronic Device and the Battery-Bank; 3. Provide charging to said Mobile Electronic Device from both the input power from said ancillary power source and said Battery-Bank to expedite charge-time; or 4. Upon completing the charging of said Mobile Electronic Device, provide the entirety of the available power to recharge the Battery-Bank.

In an embodiment incorporating elements of the invention, a Wrist-Worn Device 1 comprises a Photovoltaic Array, Controller, Battery-Bank and wrist-strap further comprising a power connection provision. The power connection provision enables either conductive or inductive charging types to allow for the Daisy-Chaining of multiple Wrist-Worn Devices 1 to assemble a combined charging unit comprised of a plurality of said Wrist-Worn Devices 1. This assembly method enables users to combine the available charge of a plurality of said Wrist-Worn Devices 1 providing a faster and larger charge to a singular Mobile Electronic Device than would be otherwise capable by a singular Wrist-Worn Device 1. Such connections enabling Daisy-Chaining include USB, coaxial, magnetic conductive, or other power connections as appreciated by one skilled in the art.

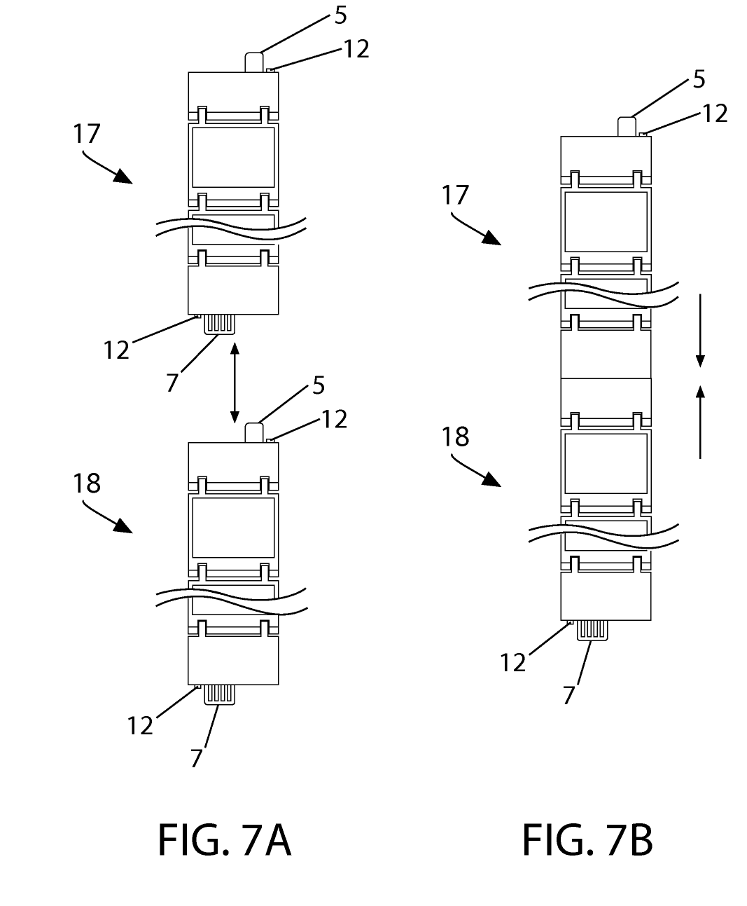

In an embodiment enabling the Daisy-Chaining of a Wrist-Worn Device 1, said device comprises of a Photovoltaic Array, Controller, Battery-Bank and Wrist-Strap. Said Wrist-Strap further comprises of a First Distal End 10 and Second Distal End 9 wherein each distal end further comprises one male connector and one female recess further comprising a female USB connector, each providing mechanical and electrical connectivity. In the current embodiment, the connectors are of the standard USB type wherein said first distal end 10 is comprised of a male USB type connector 5 and a female USB type connector 8 matching that of the male connector 7 of said second distal end 9. Furthermore, said second distal end 9 is comprised of a male USB type connector 7 and a female USB type connector 6 matching that of the male connector 5 of said first distal end. To enable daisy-chaining, an embodiment incorporates exactly one male USB connection and exactly one female USB connection on either side of the Longitudinal Axis 15 of said Wrist-Worn Device 1. In such an embodiment as demonstrated by FIGS. 7A and 7B, a Preceding Wrist-Worn Device attaches via its Second Distal End 9 to the First Distal End 10 of a separate disparate Wrist-Worn Device.

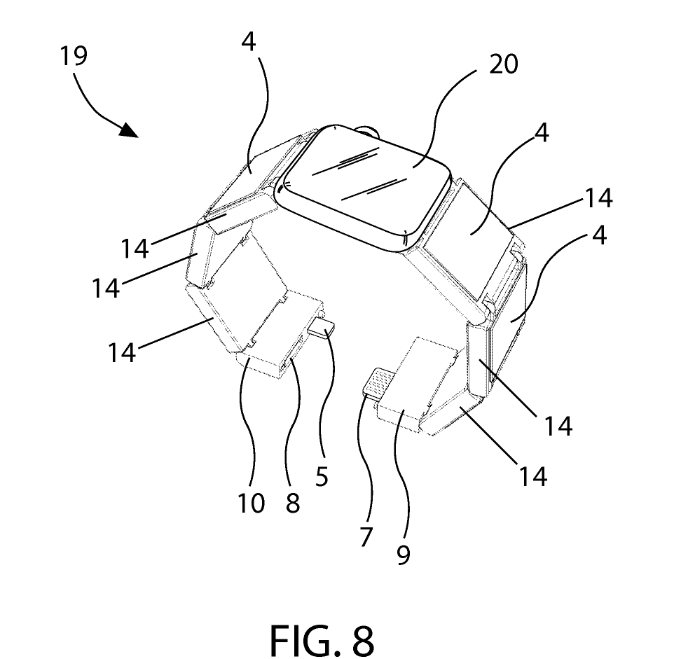

In an embodiment of the invention, a Wrist-Worn Device 1 comprised of a Photovoltaic Array, Controller, Battery-Bank and wrist strap further comprises an attachment mechanism to enable the accessory use of said Wrist-Worn Device 1 with existing Mobile Electronic Devices such as a smart-watch, as shown in FIG. 8, which typically contains a separate incorporated battery. Said attachment mechanism may provide mechanical attachment and/or charging connection. In such embodiment, the accessory use or integrated use with a smart-watch supplements the on-board battery life of said smart-watch providing longer combined battery life and battery charging on-the-go. In such embodiment said Controller may: 1. Provide Pass-Thru power to the smart-watch; 2. Charge the Battery-Bank with the power input from the Photovoltaic Array; or 3. Simultaneously charge the Battery-Bank and the on-board battery of said smart-watch.

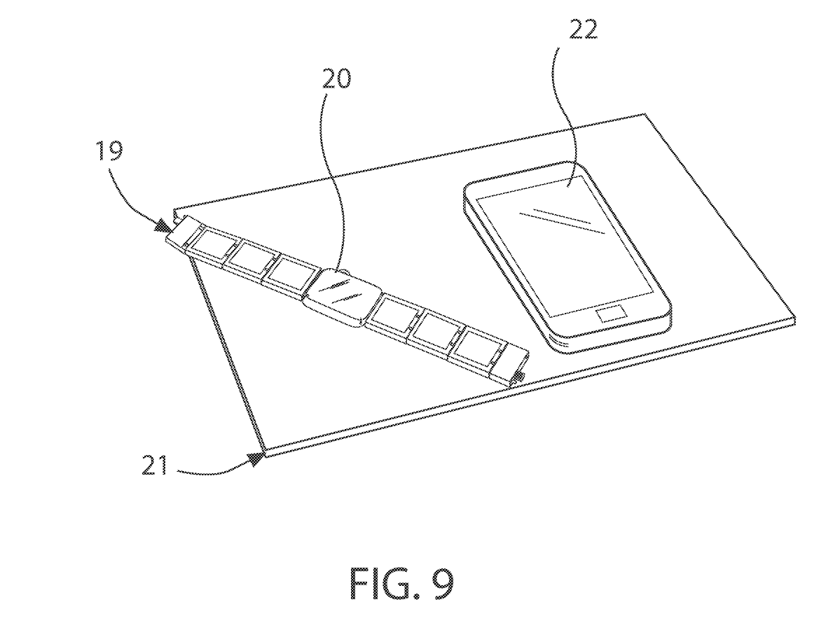

An embodiment of the invention comprising a Wrist-Worn Device 1 further comprises a Photovoltaic Array, Controller, Battery-Bank, Wrist-Strap, and an attachment mechanism enabling the use with Existing Mobile Electronic Devices such as a smart-watch as demonstrated in FIG. 9. In this embodiment, said smart-watch comprises a separate battery and inductive charging capability. Said attachment mechanism of the Device, provides mechanical attachment and inductive charging connection to provide longer combined battery life and battery charging on-the-go with the integrated Wrist-Worn Device 1. In this embodiment, the smart watch and Wrist-Worn Device 1 may be charged by USB connections at distal ends or by placing on a Inductive Charging Surface 20.

In the preferred embodiment of the invention a Wrist-Worn Device 1 comprised of a Flexible wrist-band, Battery-Bank, Photovoltaic Array, Controller, a Watch Component 2, a first USB male connector 5 and a second male USB connector 7 on corresponding first distal end 10 and second distal end 9. Said wrist-band exhibits dimensions of 30 mm (1.18 in) and 20 cm (7.87 in) in length but adjustable from 16-20 cm (6.30-7.87 in) in length accomodating the wrist size of the user and is comprised of a plurality of Non-Flexible Segments 14 attached by Pinned Joints 11 allowing for articulation around a user's wrist. Said Battery-Bank is incorporated within the Main Housing 3 and comprises of a 3.7V Lithium-Ion battery with capacity of 500-700 mAh, the dimensions of which is directly driven by current battery technology. In the preferred embodiment such battery exhibits overall volume dictated by the following dimensions: 40 mm (1.57 in)×30 mm (1.18 in)×5 mm (0.197 in). Said Photovoltaic Array comprises of a plurality of cells 4, specifically a quantity of 6 cells of output 6V×100 mA or 600 mW. Said controller further comprises of a microcontroller with a battery charge circuit and a voltage regulation circuit. Said first male USB connector 5 is selected from the group comprising of: Micro-USB A, Micro-USB B, Micro-USB AB, Micro-USB Type C, and Lightning Connector. Said second USB connector 7 is selected from the group consisting of USB A-Type, USB B-Type, USB A-Type 3.0 and USB B-type 3.0. Furthermore, said first and second male USB connectors are exhibited on opposite sides of the Longitudinal Axis 15 of said Wrist-Worn Device 1.

The method of the use of the preferred embodiment involves the user wearing the Wrist-Worn Device 1 on their wrist by mechanical attachments at the distal ends 9 and 10 of said Wrist-Worn Device 1. The active wearing of said Wrist-Worn Device 1 in areas subject to light radiation thereby continually charging the integrated Battery-Bank. To accelerate the charging of said Battery-Bank, the user may remove the Wrist-Worn Device 1 from their wrist and lay said Device in a configuration, as shown in FIG. 2, that exposes the entirety of the Outer-Surface to available light-radiation, preferably sunlight. In the scenario in which the user's Mobile Electronic Device, such as a smart-phone needs a supplementary electrical charge, the user may connect the first male USB connector 5 to said Mobile Electronic Device. By connecting said first male USB connector to said Mobile Electronic Device the available stored electrical power in the Battery-Bank is transferred to the battery of said Mobile Electronic Device. Furthermore, the user may decide to connect the second male USB connector 7 to an ancillary power source to provide coordinated or Pass-Thru charging.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The descriptive labels associated with the numerical references in the figures are intended to merely illustrate embodiments of the invention, and are in no way intended to limit the invention to the scope of the descriptive labels.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

1. A Wrist-Worn Device comprising a Photovoltaic Array, Controller, Battery-Bank and Flexible wrist-strap.

2. The Wrist-Worn Device of claim 1, said Flexible wrist-strap further comprising a first distal end and a second distal end.

3. The Wrist-Worn Device of claim 2, said first distal end further comprising at least one male USB connection and said second distal end further comprising a matching female recess.

4. The Wrist-Worn Device of said claim 3, said matching female recess further comprising a female USB connection.

5. The Wrist-Worn Device of claim 1, said Photovoltaic array capable of providing electrical generation output of at least 420 mW.

6. The Wrist-Worn Device of claim 1, said Battery-Bank exhibiting a Voltage rating of at least 3.7V and capacity of at least 500 mAh.

7. The Wrist-Worn Device of claim 1, said Battery-Bank consisting of at least one Lithium-Ion battery.

8. The Wrist-Worn Device of claim 1, said Photovoltaic Array consisting of at least 4 photovoltaic cells with a total power generation output rating of at least 450 mW.

9. The Wrist-Worn Device of claim 8, said Photovoltaic array consistings of 6 photovoltaic cells with a total power generation output rating of at least 450 mW.

10. The Wrist-Worn Device of claim 1, said Controller comprising a Battery Charge Controller and a Voltage Regulator.

11. A Wrist-Worn Device consisting of a Flexible wrist-band, a Battery-Bank, a Photovoltaic Array, a Controller, a watch component incorporating a first USB male connector and a second male USB connector on corresponding first and second distal ends.

12. The Wrist-Worn Device of claim 11, wherein said Flexible wrist-band is adjustable to a length of 16-20 cm (6.30-7.87 in) accomodating the wrist size of the user.

13. The Wrist-Worn Device of claim 11, wherein said Flexible wrist-band comprises of a plurality of rigid segments attached by pinned joints allowing for articulation around a user's wrist.

14. The Wrist-Worn Device of claim 11, said Flexible wrist-band of 30 mm (1.18 in) in width and 20 cm (7.87 in) in length.

15. The Wrist-Worn Device of claim 11, said Battery-Bank comprising of a 3.7V Lithium-Ion battery with capacity of 500-700 mAh.

16. The Wrist-Worn Device of claim 11, said Battery-Bank having the following dimensions: 40 mm (1.57 in)×30 mm (1.18 in)×5 mm (0.197 in).

17. The Wrist-Worn Device of claim 11, said Photovoltaic Array comprising of a plurality of cells of output 6V×100 mA or 600 mW.

18. The Wrist-Worn Device of claim 11, said Photovoltaic Array consisting of 6 cells of output 6V×100 mA or 600 mW.

19. The Wrist-Worn Device of claim 11, said controller further comprising a microcontroller with a battery charge circuit and a voltage regulation circuit.

20. The Wrist-Worn Device of claim 11, said first male USB connector is selected from the group comprising of: Micro-USB A, Micro-USB B, Micro-USB AB, Micro-USB Type C, and Lightning Connector; said second USB connector is selected from the group consisting of USB A-Type, USB B-Type, USB A-Type 3.0 and USB B-type 3.0, and said first and second male USB connectors are located on opposite sides of the Longitudinal Axis of said Wrist-Worn Device.
